(19) United States
(12) Patent Application Publication
(10) Pub. No.: US 2022/0111962 A1
(43) Pub. Date: Apr. 14, 2022

(54) AERIAL VEHICLE AND METHOD AND COMPUTER-AIDED SYSTEM FOR CONTROLLING AN AERIAL VEHICLE

(71) Applicant: Volocopter GmbH, Bruchsal (DE)

(72) Inventor: Markus ORTLIEB, Karlsruhe (DE)

(73) Assignee: Volocopter GmbH, Bruchsal (DE)

(21) Appl. No.: 17/498,070

(22) Filed: Oct. 11, 2021

(30) Foreign Application Priority Data
Oct. 12, 2020 (DE) 102020126689.8

(51) Int. Cl. B64C 39/02; G08G 5/00; G06F 16/29

(52) U.S. Cl. CPC B64C 39/024; B64C 2201/141; G06F 16/29; G08G 5/0039

(57) ABSTRACT

A method for controlling an aerial vehicle of a specific type, in particular a multirotor VTOL aerial vehicle with preferably electrically driven rotors, in which a) before a flight, a finite number of nominal trajectories (NT) for the aerial vehicle and a finite number of emergency trajectories (CT) arranged around the nominal trajectories (NT) are calculated and stored in a database available on board the aerial vehicle; b) before a flight, a finite number of type-specific admissible flying maneuvers of the aerial vehicle are pre-planned and stored in the database as a maneuver library; c) optionally before a flight, a number of discrete flight levels with different flight altitudes are defined and stored in the database; d) during a flight, the database is accessed by a computer-aided transition planning algorithm, in order, depending on a state of the aerial vehicle recorded by sensors, to change between the nominal trajectories (NT) and the emergency trajectories (CT) and also optionally between the defined flight levels by using the pre-planned flying maneuvers and to correspondingly activate a path-tracking controller and/or a flight control system of the aerial vehicle.

### INCORPORATION BY REFERENCE

The following documents are incorporated herein by reference as if fully set forth: German Patent Application No. 10 2020 126 689.8, filed Oct. 12, 2020.

### TECHNICAL FIELD

The invention relates to a method for controlling an aerial vehicle of a specific type, in particular a multirotor VTOL aerial vehicle with preferably electrically driven rotors.

The invention also relates to a computer-aided system (so-called motion planner) for controlling an aerial vehicle of a specific type by a method according to the invention.

Finally, the invention relates to an aerial vehicle, in particular a multirotor VTOL aerial vehicle, with preferably electrically driven rotors.

### BACKGROUND

Related work has already been performed in the past for respective partial aspects of the motion planner proposed here for an aerial vehicle. Planning environments for the creation of comprehensively pre-planned, map-based missions in the military field have thus already been developed and approved (NASA). In this case, safety was ensured by virtue of emergency landing trajectories that were pre-planned at regular route intervals and that were able to be selected in real time during flight by a state machine.

Likewise map-based, GCAS systems (Ground Collision Avoidance Systems) were developed back in the 1990s, automatically preventing collisions with the terrain through targeted maneuvers (NASA, Airbus).

Path planning with pre-planned path sections was demonstrated for the first time by Emilio Frazzoli. Earlier work was restricted to so-called motion primitives with constant trimming states, which were later extended to more complex controller specifications. Initially pre-planned paths were followed by applications in which the path was generated during the flight by on-board maneuver libraries.

Complete mission preplanning has the disadvantage that the decision-making capability (for example for an autopilot or an automatic control system) during the flight is greatly restricted, to be specific to the scenarios taken into consideration before the flight. In an environment affected by uncertainty, this requires complex preplanning, in order also to foresee and take into consideration improbable events before they occur. In practice, such an approach requires a high degree of branching in the planning network and fine temporal and/or spatial discretization, in order to be able to react to changing circumstances in sufficiently short time intervals. The degree of discretization and degree of branching linearly or exponentially affect the storage requirements for such a planning or route network. In the context of aviation, safe mission plannings therefore cannot be replicated by such a preplanning approach.

By contrast with preplanning, in which all possible flying states that an aerial vehicle can assume during the mission are known in advance and can be verified (certified), planning algorithms performed on the flying platform (i.e. the aerial vehicle itself) have much more restricted transparency properties. These are often optimization- or sampling-based approaches, which do not have a strictly deterministic behaviour. In particular in the case of certifying the planning environment for passenger-carrying aerial vehicles, this represents a serious obstacle.

Therefore, the prior art has definite shortcomings with respect to algorithms that can be used in the civil sector for autonomous aviation navigation in complex environments with high safety requirements and at the same time limited storage requirements.

### SUMMARY

The invention is based on the object of remedying this and providing a method or a motion planner and a correspondingly equipped aerial vehicle with which autonomous aviation navigation is made possible in complex environments with high safety requirements and at the same time limited storage requirements.

The method of motion planning described here overcomes the shortfall existing in the prior art as to how it can be ensured with manageable storage requirement to be able to react to unforeseen events at any time, while the inspectability and quasi-deterministic properties of the solution are preserved, which is required for reasons of safety and certification.

The object set out above is achieved by a method with one of more of the features disclosed herein, by a system with one or more of the features disclosed herein, and by an aerial vehicle with one or more of the features disclosed herein. Advantageous developments are specified below and in the claims.

In the case of a method according to the invention for controlling an aerial vehicle of a specific type, in particular a multirotor VTOL aerial vehicle with preferably electrically driven rotors, it is provided that

a) before a flight, a finite number of nominal trajectories for the aerial vehicle and a finite number of emergency trajectories arranged around the nominal trajectories are calculated and stored in a database available on board the aerial vehicle;

b) before a flight, a finite number of type-specific admissible flying maneuvers of the aerial vehicle are pre-planned and stored in the database as a maneuver library;

c) optionally before a flight, a number of discrete flights levels with different flight altitudes are defined and stored in the database;

d) during a flight, the database is accessed within a real-time algorithm by a computer-aided transition planning algorithm, in order, depending on a state of the aerial vehicle recorded by sensors, to change between the nominal trajectories and the emergency trajectories and also optionally between the defined flight levels by using the pre-planned flying maneuvers and to correspondingly activate a path-tracking controller and/or a flight control system of the aerial vehicle.

In the case of a computer-aided system according to the invention for controlling an aerial vehicle of a specific type by the method according to the invention, in particular a multirotor VTOL aerial vehicle with preferably electrically driven rotors, with at least one computer unit, which is designed as a ground-based computer unit and/or as an on-board computer unit of the aerial vehicle, the computer unit is designed and configured for:

A) performing a preplanning algorithm for carrying out method step a);

B) providing the database;

C) performing a real-time algorithm which provides a decision module, the input of which is the state of the aerial vehicle according to method step d) and the output of which is a trajectory that corresponds best to the current state of the aerial vehicle from the finite number of nominal and emergency trajectories in accordance with an evaluation metric;

D) performing the transition planning algorithm according to method step d).

An aerial vehicle according to the invention, in particular a multirotor VTOL aerial vehicle with preferably electrically driven rotors, is equipped with a system according to the invention.

Serving as a basis for the path planning is a precalculated structure of a finite number of nominal paths or corresponding trajectories and a likewise finite number of emergency or contingency paths or corresponding trajectories arranged around the nominal paths, preferably in a tree structure. In addition, discrete flights levels between which the aerial vehicle can change are optionally defined. By the use of maneuvers stored in a database and a transition planning algorithm performed in real time on board the aerial vehicle, with preferably a restricted time horizon, it is possible to change flexibly in real time and in response to changed circumstances or events between different flight paths and optionally also between different flight altitudes (so-called transition), while the storage requirement is manageable and complete inspectability is ensured. The changing of flight altitude referred to is only optional because the method according to the invention can in principle also be used advantageously just on one level, that is to say in two dimensions.

A planning method or a transition planning algorithm with a restricted time horizon calculates in each planning step just a planning solution for a limited time interval (by contrast with a planning solution up to a target point of the flight path). As a result, the required calculation time per update cycle is generally shorter than in the case of planning methods which plan up to the target point in each time increment. Although results of such methods are not optimum, they produce results quickly, and the results are (can be) as close as desired to the optimum solution.

A development of the method according to the invention correspondingly provides that the emergency trajectories are arranged in a tree structure and/or at regular intervals, while preferably the path planning in step a) takes place by quasi-random algorithms for path planning, which process is most preferably repeated up to a desired degree of branching on the emergency trajectories generated in a previous step, so as to produce a tree-like flight path structure, which can be stored in the database and allows a flexible response to events.

If deterministic or analytical solutions are impossible, recourse is generally made to sampling-based planning approaches, which open up the search space by the use of randomly generated sampling points. Quasi-random methods open up the search space on the basis of non-random criteria (but nevertheless sampling-based). As a result, the deterministic behavior of the planning method can be restored.

Another development of the method according to the invention correspondingly provides that the transition planning algorithm has a restricted time horizon. As a result, the system requirements can be reduced, with the effect in particular of reducing the requirements for the on-board systems, as a result of the chosen methods involving less computational effort.

Before and after a transition, the aerial vehicle moves on precalculated flight paths that are stored in the database. The terms “path” or “flight path” and “trajectory” are used here and hereinafter as synonyms.

Transitions between flight altitudes (flight levels) and paths are preferably only possible in so-called exit and entry intervals that are defined in advance for each trajectory. With a corresponding configuration, a correspondingly designed contingency or emergency module of the path planner decides on a broad base of aerial-vehicle-specific parameters and environment variables (preferably recorded by sensors) whether a transition is required, and if so to which trajectory or flight level. The total set of pre-planned flight paths and defined transition intervals remains inspectable in advance and is adaptable to the local conditions.

By specifying constraints, it is possible for regulations, no-fly zones, weather conditions and much more besides to be taken into consideration in the planning solution. Flying bans between two trajectories can be taken into consideration for example by preventing the transition from one trajectory to the other in areas that entail flying through the prohibited zone by corresponding definition of exit and entry intervals.

A preferred development of the method according to the invention provides in this respect that, before the flight, entry and exit intervals are defined for each trajectory and that a change between trajectories and flight levels is only admissible within these entry and exit intervals.

Another development of the method according to the invention provides that, in step d), it is determined by interaction of an emergency module and a transition planning algorithm on the basis of aerial-vehicle-specific parameters and environment variables whether a transition is required, and if so to which trajectory and/or flight level.

In order to achieve a further reduction in planning complexity, in a development of the method according to the invention (in step d)) the horizontal transition between different flight paths can be completely decoupled from the vertical transition between flight levels. As a result, discrete changes of the flight level can be implemented as and when required alone on the basis of a controller and without the need for a preceding planning algorithm.

With a corresponding configuration or development, the specified method calculates both a combination of individual paths and closed sets of reachable paths (these are pre-planned paths along with conservatively estimated transition intervals between the pre-planned trajectories). As a result, a difficult planning problem can be implemented in a solvable manner in real time on embedded computers (that is to say computer units on board an aerial vehicle) in spite of narrow limits (for example spatial extent, flight performance). The database preferably comprises both explicitly precalculated trajectories that lead to a landing site and volumes defined in advance, within which an online/real-time planning algorithm calculates a trajectory at run-time, in order for example to change between two precalculated trajectories. Alternatively, a likewise precalculated maneuver, for example a holding pattern, may be performed in such a volume. It is advantageous that a trajectory planned at run-time within such a volume always starts and ends on a precalculated trajectory. The starting trajectory and target trajectory may be identical, but do not have to be. The online/real-time planning algorithm ensures when it is performed that trajectories outside the defined volume cannot be reached.

If a completely precalculated maneuver, such as a holding pattern or a change of the flight level, is performed in a transition interval, the path, including starting and end points, is determined on precalculated trajectories. In the case of a transition between two trajectories by an online planning algorithm, the path is first planned at run-time, it being ensured in a configuration of the invention that the interval defined in advance is not left. It is consequently not the exact path that is known, but the set of all possible states during the transition.

Implementation that can be solved in real-time is preferably made possible by quasi-deterministic preplanning by way of quasi-discrete states in combination with a strict prioritization and limitation of the number of flight paths and maneuvers taken into consideration. Different contingency strategies are preferably prioritized according to mission-specific criteria. For example, it would be obvious to prefer temporal conflict solutions over spatial conflict solutions. This can be achieved by changing the speed without changing the spatial flight path, in order to avoid a specific spatial position at a specific time. Furthermore, vertical maneuvers may be prioritized more than horizontal maneuvers (assumption: horizontal maneuvers are more likely than vertical maneuvers to cause conflicts with obstacles in an urban environment).

This leads to increased planning flexibility during the flight and allows the integration of reactive planning components (for example changing to a different flight path). In addition, with the same transparency and verifiability, the complexity of the preplanning and also the storage complexity of the planning solution to be kept on the aerial vehicle are decisively reduced. As a result, every possible event that may occur during the flight is already adequately taken into consideration before departure, as a result of which in particular comprehensibility to operators, airspace management (ANSPs: Air Navigation Service Providers) and aviation authorities is ensured.

Within the scope of a preferred configuration, the path planning method comprises in particular the following capabilities:

1. Preplanning of the flight path in an urban environment;

2. Taking into consideration landing sites and alternate routes;

3. Separation from adjacent air traffic (=“well-clear” function; specified by ATM/UTM—Air Traffic Management/Unmanned Aircraft System Traffic Management).

It is based in particular on the following constraints, which preferably must be specified before departure:

1. Landing site information, hazard potentials, airspace structures, etc. are provided in the form of an expanded 3D map of the flying area, this serving as a basis for the path planning method.

2. Limited disturbing effects during nominal operation (for example maximum wind and gust strength) are taken into consideration. The off-line planning is based on data available at the time of planning and takes into consideration the expected changes in current conditions, preferably within the flight envelope. Preferably, real-time data can be taken into consideration in the course of the analysis of post-optimal sensitivities during the flight. The invention is not however restricted to this.

3. Flight performance parameters (for example dynamics and kinematics) of the aircraft are known and are taken into consideration. These parameters are included in the planning algorithm as constraints and are consequently taken into consideration in the planning solution. This can be technically implemented by manual input (in an individual case), but preferably linking up with a stored model of the aerial vehicle.

4. Model quality (=deviation between the model and observed flying behavior) is taken into consideration. A model should be understood here as meaning a mathematical replication of the aerial vehicle and its environment on the basis of simplifying assumptions. The model is included in the planning algorithm, in order to make it possible for the planning solution to be adapted to the specific aerial vehicle and its environment. For the consideration of associated uncertainties, an estimate of the model quality is made and included in considerations.

5. On the basis of the aforementioned points 2.-4., an analysis of the reachability set (=combined set of all possible paths that can result from a specific controller specification on the basis of deviations) is carried out. The so-called reachability analysis analyzes which states a system can reach on the basis of its momentary state and on the basis of control and disturbance variables. The result is used in point 6 to synthezise controllers, which controllers minimize the reachability set for the performance of the respective maneuver.

6. Maneuver libraries (=a finite set of possible flight path segments for path planning) are defined and provided, taking into consideration the reachability set.

7. There is a possibility for state automation, whereby the transition method or the transition planning algorithm is replicated in the form of a finite state machine.

A development of the method according to the invention correspondingly provides that reachability sets are determined on the basis of at least one of the following:

i) disturbing effects during nominal operation, for example maximum wind and gust strength;

ii) known flight performance parameters, for example dynamics and kinematics, of the aerial vehicle;

iii) model quality in the form of a deviation between a physical model of the aerial vehicle, used as a basis at least for step a), and an observed or measured flying behavior.

In the case of another development of the method, it may also be provided that the reachability sets are used for the preplanning of the flying maneuvers in method step b).

In the case of yet another development of the method, it may be provided that landing site information, hazard potentials, airspace structures, etc. are provided in an expanded 3D map of the flying area, which map serves as a basis for the trajectory planning in method step a).

With a corresponding configuration of the invention, the multistage path planning process comprises:

1. Identification of alternate landing sites on the map and classification according to criteria (safety, hazard potential caused by the environment, suitability, reachability, etc.); this is preferably performed in an automated manner by the analysis of geographical databases and evaluation of satellite images. There is also the possibility of manually adding additional landing sites or deleting already identified landing sites from the database. Among the criteria according to which landing sites are selected are the following: direction and angle of approach, ground condition, risk evaluation of the environment, profile of the terrain, plant covering/vegetation.

2. Preplanning of an optimized nominal trajectory on the ground, for example on a user PC or before take-off on board the aerial vehicle.

3. Preplanning of contingency or emergency trajectories at regular intervals on the ground on a user PC or before take-off on board (preferably as a tree structure).

4. Definition and assignment of (transition) intervals, within which intervals the trajectories/flight levels may be left or entered.

5. Real-time planning of the actual flight path along the nominal trajectory and within the set of all contingency trajectories on board the aerial vehicle, preferably comprising:

i) Updating a system state of the aerial vehicle (in the manner of a state machine); the configuration of a state machine describing the aerial vehicle depends greatly on the aerial vehicle taken as a basis. The present invention is not restricted to a specific aerial vehicle. It is important that a change in the state of the aerial vehicle or its environment can be accompanied by a change in the trajectory to be flown. Generally, a state machine or a finite state machine (FSM) is a model of a behavior, consisting of states, transitions between states and actions. Such a machine is known as finite if the set of states that it can assume is finite. A finite machine is a special case from the set of automatic machines.

ii) Derived from this, updating the trajectory and/or flight level to be flown;

iii) Updating the selected path from a previous time increment while taking into consideration an evaluation function and possibly transition to a new path by for example a model-based planning method with a restricted time horizon. Path and trajectory are used here as synonyms although, strictly speaking, a path only comprises spatial information, whereas a trajectory also includes information about the temporal derivatives of the path. For each time increment it is evaluated whether the current trajectory (that is to say the one selected in the previous time increment) still represents the best option for reaching the target. Model-based methods use information based on the modeling of important influencing variables in the process of finding a solution. This may be in this case a model of the planning environment (for example: obstacle map, surface model, weather model) and/or a model of the aerial vehicle (dynamic or kinematic model).

A development in this respect of the method according to the invention may correspondingly provide that, in step d), a time-incremental real-time planning of the actual flight path along a nominal trajectory and within the set of all emergency trajectories takes place on board the aerial vehicle, including:

i) updating a system state of the aerial vehicle (state machine);

ii) derived from this, updating the trajectory and flight level to be flown;

iii) updating a selected path from the previous time increment ii) while taking into consideration an evaluation function and, if need be, a transition to a new path, in particular by a model-based planning method with a restricted time horizon.

The state machine is independent of the flight guidance level. Therefore, two update cycles of independent systems, which merely exchange information with one another, preferably exist.

The method described here is preferably carried out to varying extents on the ground and during the flight on board the aerial vehicle. The place where the ground component is performed may be the on-board computer (on-board computer unit, so-called embedded system) of the aerial vehicle while it is on the ground or else an external computer, for example a user PC, from which the planning results are transferred to the aerial vehicle in an intermediate step before takeoff.

A corresponding development of the method according to the invention provides that steps a) to c) are performed on a ground-based computer and the result is subsequently transferred to the aerial vehicle and is stored on board the aerial vehicle in the database; or that steps a) to c) are performed on an on-board computer of the aerial vehicle and the result is stored on board the aerial vehicle in the database.

The real-time component is preferably performed in flight and on board the aerial vehicle on the available on-board computer unit. The algorithm used here is preferably designed in such a way that it can be performed both on a computer with a user operating system and on embedded systems. However, a more precise specification of the hardware is not the subject of the present invention.

In order to simplify the real-time planning and execution of a flight connection between two points in space, the mission is preferably pre-planned in part on the ground on the basis of existing maps (see the description of the constraints). The results of this are stored in the aforementioned database on board the aerial vehicle and therefore taken along during the flight. With the assistance of this database, the complexity of the real-time algorithm can be reduced decisively. This reduction in preplanning and storage effort constitutes a significant part of the present invention.

For preplanning on a global level, at least one so-called maneuver library, preferably a number of maneuver libraries, is or are preferably calculated for the aerial vehicle, in particular for different scenarios of use and operation. These comprise (flying) maneuvers that are completely precalculated and kept in the database. In the calculation of these maneuvers, the reachability set defined above is taken into consideration. Instead of storing a maneuver in the form of a series of states, maneuvers are stored in the maneuver library as executable controllers. These controllers are optimized to the extent that the set of states that can be reached by the execution of a controller with the assumption of a limited disturbing effect or the possible deviation from the target state becomes minimal. The information concerning this reachable set is ascribed to the maneuver/controller as an attribute. A path planner which combines a number of maneuvers into a trajectory can make decisions on the basis of this information. For example, the possibility of a collision by performing a maneuver in a starting state can be ruled out if the set that can be reached by execution is collision-free. Accordingly, a control law is derived from a maneuver to be performed and is optimized such that the expected deviation from the setpoint trajectory is minimized. This process is also referred to in the present case as “controller synthesis”. The maneuver library comprises at least one discrete representation of the flight envelope while taking into consideration various performance states of the aerial vehicle (for example nominal state, failure scenarios, environmental conditions) and is optimized in terms of memory by using symmetries and superposition. The envelope can only be exactly described by continuous methods. Since a continuous description requires an infinite number of maneuvers, the actual envelope is approximately described by a sufficiently fine network of discrete states. These discrete states serve as trimming states and are connected by further discrete maneuvers. As a result, the envelope can be taken into consideration sufficiently exactly with reasonable effort in terms of computation and memory. As far as the mentioned performance states are concerned, the discretization network remains the same, but the limits of the envelope change. This can optionally be described in the most effective state as a number of representations or as subsets of the envelope. For reasons of efficiency, implementation preferably uses the last-mentioned variant.

For memory optimization, the following procedure can be followed: the dynamic properties of most aerial vehicles are symmetric along the rolling axis and the yaw axis. It is accordingly preferably sufficient to define and store states of the curved flight in the positive direction. The opposite motion is then obtained from the negation of the stored states. In the case of the applicant's Volocopter® aircraft, this symmetry can within certain limits also be generalized for the pitching axis. The same principle may be generalized for the derivatives of the rotational motion and also the translational motion and their derivatives.

Superposition properties come to bear where states can be produced by superposing two elementary states without having to store a dedicated maneuver. Thus, in the case of the Volocopter® aircraft, for example the horizontal and vertical motion can be considered completely decoupled within the flight performance limits. An ascending flight with a curve to the right may be generated for example by superposing a vertical ascending maneuver and a level curve to the right, without this having to be explicitly stored in the database.

A corresponding development of the method according to the invention provides for this purpose that the maneuver library comprises at least one discrete representation of a flight envelope of the aerial vehicle while taking into consideration various performance states of the aerial vehicle, such as the nominal state, failure scenarios or environmental conditions, and is preferably stored in an optimized manner in terms of memory by using symmetries and superposition, the maneuver library most preferably being specifically designed for a given type of aerial vehicle.

Furthermore, parameterized trajectory segments are defined. These should be understood as meaning (partial) flight paths that can be performed locally, which do not entail any change of the selected (nominal) trajectory, but return to it once they have ended. They are path sections described independently of a global reference that can be performed at any point in time on the basis of the current state of the aerial vehicle. Examples may be holding patterns, time-limited changes in the speed along the flight path or ascending and descending flights for changing the flight level alone.

A corresponding development of the method according the invention provides for this purpose that additionally parameterized trajectory segments are defined and stored in the database, understood as meaning flight paths or partial flight paths that can be performed locally, do not entail any change of a selected trajectory but return to this trajectory once they have ended, for example holding patterns, time-limited changes in the speed along the flight path or ascending and descending flights for changing the flight level.

The maneuver library is preferably specifically designed for a specific type of aerial vehicle. All of the modules derived from it can consequently be used for all aerial vehicles of the same type. If many aerial vehicles of the same type are used, it is sufficient to generate the maneuver library for this type of aerial vehicle once and reproduce it for all of the individual aerial vehicles. This likewise applies to all subsets of the global library, for example for different system states.

In the case of preplanning on the ground at mission level, different data layers of the map may be fused to form an abstract hazard potential, which represents the density of undesired influences on the aerial vehicle and its mission in dependence on the location. Various semantic data layers may be for example: terrain, population, airspace maps, obstacle maps, traffic data, motion profiles, weather maps. The process of risk evaluation (risk metric) is described in the patent application EP20170891.4, to the content of which reference is made at this point.

A weighted cost function from this hazard potential, the number and type of reachable emergency landing sites and also the energy efficiency is preferably used for the optimization of a flight route between a starting point and an end point. The flight route thus created can then be expanded with trajectories for different flight planning modes, i.e. a different route between the starting point and the end point may result, depending on the mode. At fixed route or time intervals, contingency trajectories to the mission target (end point) and to alternate landing sites are calculated and stored in the database.

Trajectories are preferably calculated per route interval, while taking into consideration various states of the aerial vehicle (nominal, failure scenarios, operational events) and optimization targets, and are stored in the database. Optimization targets may be inter alia time, safety or efficiency optimality.

The path planning itself preferably takes place by quasi-random algorithms for path planning that are known per se. Deterministic properties can in this way be enforced. This process can be repeated up to a desired degree of branching for the contingency trajectories generated in a previous step, so that a tree-like flight-path structure is produced.

In a next step, each trajectory may be assigned transition intervals, within which the respective trajectory can be entered or left. Furthermore, the trajectories may be assigned flight levels with likewise specified transition intervals for changing the flight level (flight altitude).

Each trajectory is preferably described on the basis of properties on the basis of which a real-time algorithm (transition planning algorithm) can make decisions concerning the trajectory selection. Relevant properties may be for example the length/duration, maximum speed/load factor, energy requirement or risk metric. The properties are stored in the database as attributes of the trajectory.

A corresponding development of the method according to the invention therefore provides that each trajectory is characterized on the basis of properties stored in the database, on the basis of which properties the transition planning algorithm makes decisions in step d) concerning the trajectory selection, relevant properties being for example a length or duration, a maximum speed or an admissible load factor, an energy requirement or a risk metric.

If the preplanning takes place on an external computer, the database of the preplanning is transferred to the aerial vehicle before the flight. The database provides functions for the return of individual trajectories with a deterministic and limited run-time. Accordingly, the database processes inquiries and provides the trajectory when a corresponding inquiry is made. The simplest example of this may be (without restriction) an SQL interface. The run-time of the inquiry is limited and deterministic. This is generally the case when simple database searches are used. However, the invention is not tied to the use of a specific protocol.

In the case of real-time planning and execution on board the aerial vehicle during the flight, a corresponding software module as part of the system preferably decides which of the trajectories and flight levels calculated in advance is best in the sense of previously fixed criteria at the respective point in time and transfers this trajectory to a path-tracking controller, which correspondingly controls the aerial vehicle and provides the necessary control commands. If a change of the flight level or trajectory is required, this preferably takes place at a nearest branching point (temporally or locationally) of the described tree structure, or else by the described transition planning algorithm in the nearest transition interval if no transition along the tree structure is possible.

A corresponding development of the method according to the invention provides that a change of the flight level and/or trajectory takes place at a nearest branching point of the tree structure or by the transition planning algorithm in the nearest entry/exit interval if no transition along the tree structure is possible.

As the mission increasingly progresses, trajectories that cannot be reached any longer may be removed from the decision module and therefore the set of trajectories taken into consideration may be reduced to the set of trajectories that can still be reached in the current flying state, in order to reduce the complexity. Furthermore, the set of trajectories that can be reached is preferably filtered on the basis of their properties and, for example in the case of reduced remaining maneuverability of the aerial vehicle, is reduced (further).

A corresponding development of the method according to the invention provides for this purpose that, as the mission increasingly progresses, trajectories that cannot be reached any longer are removed and the set of trajectories taken into consideration is reduced to the set of trajectories that can still be reached in the current flying state of the aerial vehicle, the set of trajectories that can be reached preferably being filtered on the basis of their properties and, in particular in the case of reduced remaining maneuverability, reduced further.

The real-time algorithm preferably comprises a decision module, which determines from the momentary system state of the aerial vehicle the combination of trajectory and flight level to be flown. At each time increment, the algorithm can choose between a finite number of discrete trajectories which respectively corresponds to the nominal path, a contingency trajectory or a trajectory segment to be performed temporarily (for example from the maneuver library).

A corresponding development of the system according to the invention provides for this purpose that the real-time algorithm is designed to select at each time increment between a finite number of discrete trajectories that respectively corresponds to the nominal path, an emergency trajectory or a trajectory segment to be performed temporarily.

Changes between trajectories that are not replicated in the mentioned tree structure are preferably performed by a maneuver-based transition planning algorithm within transition intervals defined in advance, as already mentioned. Remaining within these intervals is algorithmically ensured, for example by the use of methods with performance guarantees (controller synthesis with minimization of the reachability set). Furthermore, volumes, which the algorithm then cannot leave, can be defined by way of constraints.

A corresponding development of the system according to the invention provides for this purpose that the transition planning algorithm is designed for instigating a change between trajectories that are not replicated in the tree structure within the exit and entry intervals.

Presupposing a corresponding guideline of the aviation authorities, the individual steps of the described method can be allowed and integrated to form a solution that is allowed overall.

The described method can—as already mentioned—be carried out to varying extents on the ground and during the flight on board the aerial vehicle. The place where the ground component is performed may be the on-board computer of the aerial vehicle while it is on the ground or else an external user PC, from which the results are transferred to the aerial vehicle in an intermediate step before takeoff, as likewise already mentioned. The real-time component is performed in flight and on board the aerial vehicle, on an on-board computer unit available there.

The (transition planning) algorithm provided for this is preferably designed in such a way that it can be performed both on a computer with a user operating system and on embedded systems. However, the precise specification of the hardware is not the subject of the invention.

The preplanning algorithm comprised by a system according to the invention may have or receive the following inputs:

1. Map material: map data in the form of popular map formats, for example tiff, geotiff, kml, geojson, sdts, shapefiles, . . . ;

2. Starting and target coordinates: input as a text file or via a user interface.

It may produce the following outputs:

1. geo-referenced, parameterized or non-parameterized trajectories with transition intervals, preferably in tabular form;

2. parameterized trajectory segments (change of flight level, holding patterns, etc.) for storage/transfer to the (on-board) database.

A corresponding development of the system according to the invention provides within a practical implementation that the preplanning algorithm has: inputs for map data in the form of popular map formats and also for starting and target coordinates, for the input of which preferably a text file or a user interface is provided, and outputs for geo-referenced, parameterized or non-parameterized trajectories with exit and entry intervals, preferably in tabular form, and also for parameterized trajectory segments for changes of flight level, holding patterns, etc., which can be transferred to the database or can be stored in the database.

The mentioned (on-board) database preferably contains:

1. Map material of the mission (for reactive path planning methods);

2. The mission preplanning (trajectories and trajectory segments, see above);

3. The maneuver library with performance guarantees; for such maneuvers, the maximum deviation from the setpoint trajectory may be specified while taking into consideration the system properties and the assumption of maximum disturbances. The system cannot physically reach states outside this interval.

4. Prioritization protocols or evaluation metrics for trajectory selection. Different contingency strategies are prioritized according to mission-specific criteria. For example, it would be obvious to prefer temporal conflict solutions over spatial conflict solutions. This can be achieved by changing the speed without changing the spatial flight path, in order to avoid a specific spatial position at a specific time. Furthermore, vertical maneuvers may be given a higher priority than horizontal maneuvers (assumption: horizontal maneuvers are more likely than vertical maneuvers to cause conflicts with obstacles in an urban environment). Relevant properties may be for example length/duration, maximum speed/load factor, energy requirement or a risk metric.

The mentioned real-time algorithm may comprise in particular a decision module, the input of which represents a system state from the system monitoring. Its output produces the best trajectory in the current state in accordance with the evaluation metric.

The actual transition planning algorithm preferably receives as input:

1. a state vector consisting of a state estimation (in particular on the basis of a sensor data fusion of different sensors or sensor data);

2. the exit and entry intervals (i.e. the transition intervals) from the database;

3. the starting and target states from the database (the state comprises in addition to the location also its change over time and also the position and change over time);

4. the maneuver library from the database;

5. the target trajectory and the flight level;

5. the maneuver prioritization from the database.

Its output produces a so-called path vector (p, \dot{p}, \ddot{p}, [symbol] , ψ, \dot{ψ}, \ddot{ψ}) for the position controller of the aerial vehicle, with the position specification p and also its temporal derivatives and the yaw angle Ψ as well as its temporal derivatives. The position controller is a closed loop arranged downstream of the path-tracking controller.

A corresponding development of the system according to the invention provides for the purpose of practical implementation that the transition planning algorithm has: inputs for a state vector consisting of a state estimation of the aerial vehicle, preferably in the form of a sensor data fusion of different sensors, for exit and entry intervals from the database, for starting and target states from the database, for the maneuver library (in particular from the database), for a target trajectory and target flight level and also for a maneuver prioritization from the database, and an output for a path vector (p, \dot{p}, \ddot{p}, [symbol] , ψ, \dot{ψ}, \ddot{ψ}) for outputting to a position controller (the outermost control loop of the flight control system) of the aerial vehicle with the position specification p and its temporal derivatives and also the yaw angle Ψ and its temporal derivatives. The starting state is the state of the aerial vehicle on the current trajectory at the point in time of initiation of the transition to another trajectory, the target state is the state on the target trajectory in which the aerial vehicle is intended to switch to the new trajectory.

Within the scope of the invention, the system may have a preplanning unit. This is preferably a computer (for example embedded, a user PC, or cloud-based), on which the preplanning algorithm is performed. The location and the type of this computer are expressly not defined any more precisely, since it may be both an on-board computer of the aerial vehicle (when it is on the ground) and an external computer, for example in a ground control station, a centrally managed server or cloud-based architectures, from which the pre-planned missions are transferred to the aerial vehicle.

In the decision module there may generally be an algorithm which, in dependence on events to be defined and filtering of the (trajectory) database on the basis of evaluation metrics to be defined, provides the most suitable trajectory at each point in time for reaching the mission target. The decision module is executed on board the aerial vehicle and during the flight. Serving as input are a (trajectory) database and also a monitoring algorithm, which determines the respective state of the system (aerial vehicle) and its environment on the basis of sensor data and as such is expressly not the subject of this invention in its configuration.

A real-time control unit may be a computer on board the aerial vehicle (embedded or a user PC), on which the algorithm for controlling the aerial vehicle is performed. On the basis of the results of the preplanning and the specification of the decision module (see above), the flight path for the transition between (pre-planned) trajectories is calculated on the real-time control unit and/or a trajectory from the database is passed on to the flight controller.

### BRIEF DESCRIPTION OF THE DRAWINGS

Further properties and advantages of the invention become apparent from the following description of specific exemplary embodiments with reference to the drawing.

FIG. 1 shows a possible configuration of the aerial vehicle according to the invention;

FIG. 2 schematically shows the reachable set EM of flight paths for an aerial vehicle;

FIG. 3 schematically shows a content of the maneuver library;

FIG. 4 shows a graphical representation of a mission planning for an aerial vehicle;

FIG. 5 shows nested contingency trajectories in a tree structure;

FIG. 6 shows an (online) transition, calculated in real time, between two precalculated trajectories; and

FIG. 7 shows a block diagram/flow diagram of the described path planning method with hardware allocation.

### DETAILED DESCRIPTION

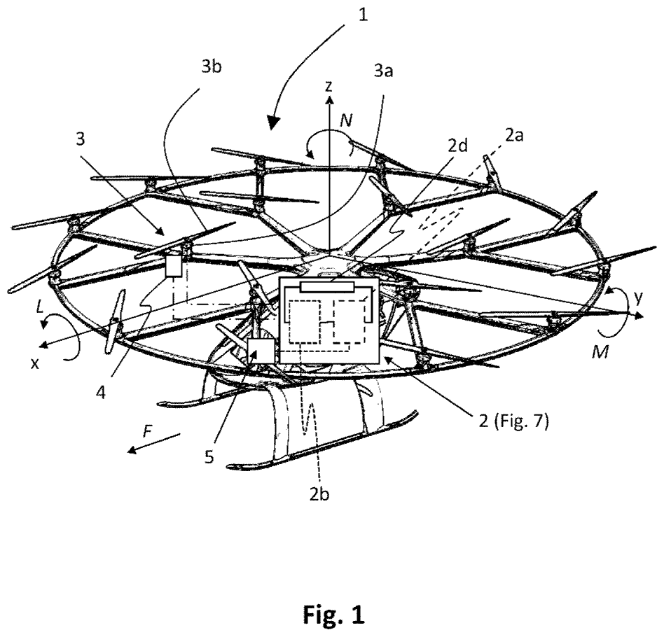

FIG. 1 shows a possible configuration of the aerial vehicle according to the invention as a multirotor eVTOL 1 with in the present case 18 drive units 3, only one of which is explicitly denoted in FIG. 1. According to the representation shown, each drive unit 3 comprises an electric motor 3a and a propeller 3b. According to the configuration of the aerial vehicle 1 in FIG. 1, the drive units, in particular the propellers 3b, are not pivotable. x, y and z denote distinguished axes of the aerial vehicle 1; L, M and N denote the associated (control) torques.

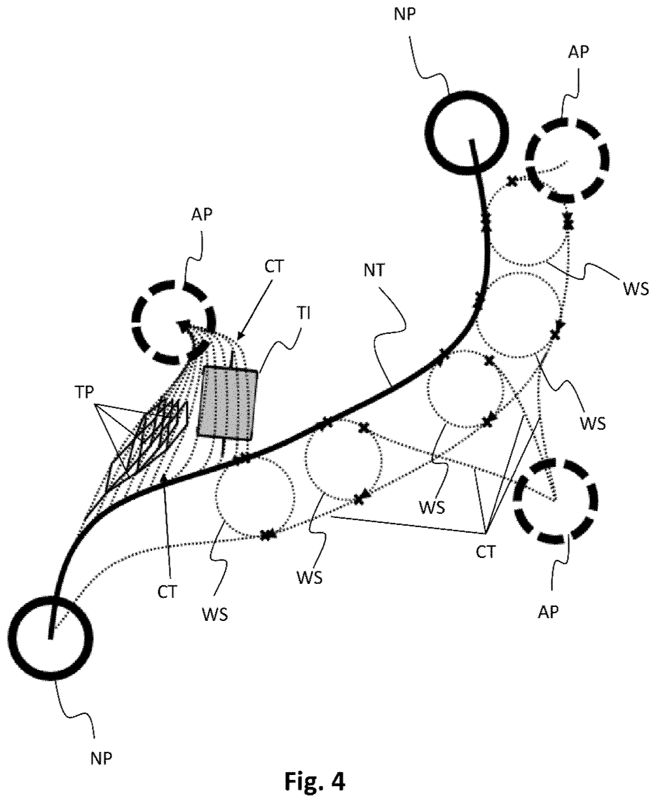

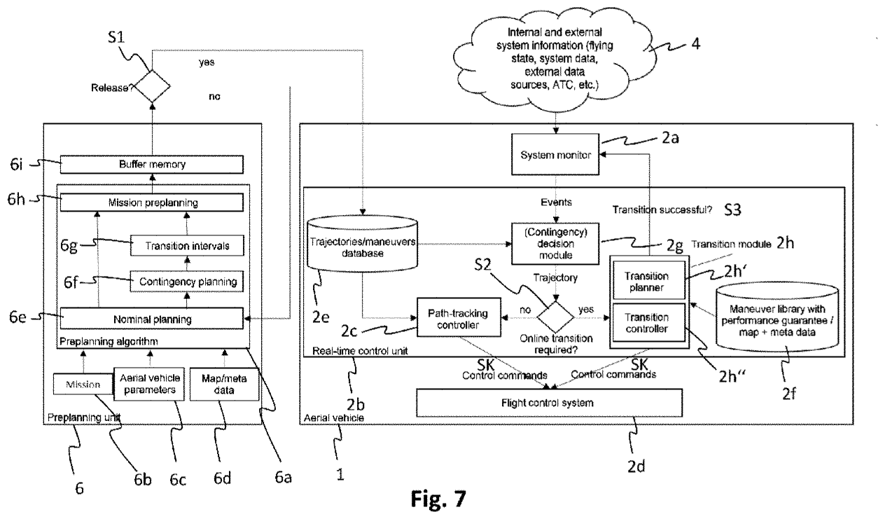

The aerial vehicle 1 has at reference sign 2 a flight control unit, which is described even more specifically further below on the basis of FIG. 7. The flight control unit 2 comprises in addition to a system monitor 2a also at reference sign 2b a real-time control unit, which is designed, preferably programmed, for (partially) carrying out the method according to the invention. Reference sign 4 denotes by way of example a sensor unit which is operatively connected to the system monitor 2a; the aerial vehicle 1 will generally comprise a multiplicity of such sensor units 4, which are in particular designed and suitable for determining an (overall) state of the aerial vehicle 1 (system state) and its environment. Represented at reference sign 5 is a pilot input unit, by way of which a human pilot (not shown) transmits its control requirements to the aerial vehicle 1, for example by way of a joystick or the like. However, within the scope of the invention, the aerial vehicle is in particular also capable of flying without human pilots, i.e. by an autopilot or the like. For determining the system state, the flight control device 2 may also use a physical model of the aerial vehicle 1, which is not represented any further in FIG. 4. The real-time control unit 2b interacts with the actual flight control system 2d or may comprise it (see FIG. 7), in order by suitable commanding of the drive units 3 to control the aerial vehicle 1 along a flight path that is precalculated and adapted in real time, as already described in detail.

Preferably, the flight control unit 2 determines by using the real-time control unit 2b the trajectory to be flown, as described in detail above, and correspondingly activates a path-tracking controller/the flight control system of the aerial vehicle 1 (cf. FIG. 7).

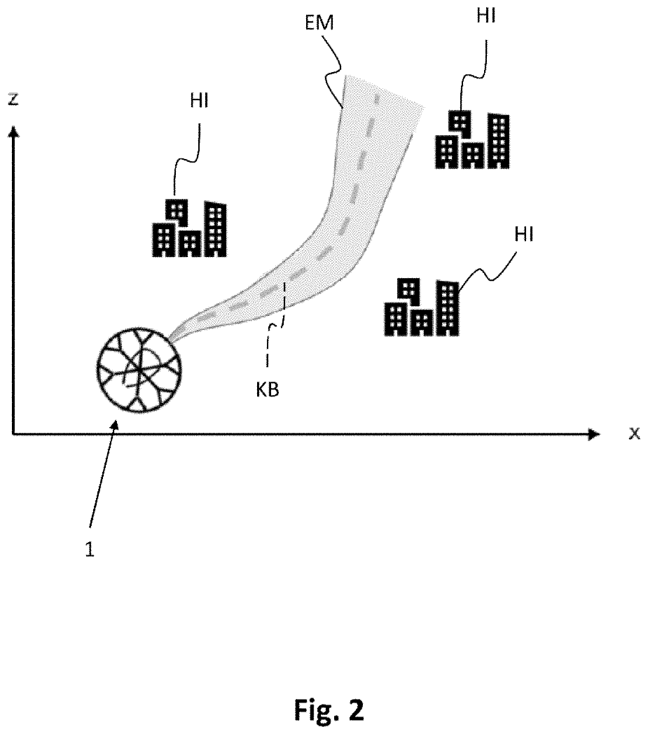

FIG. 2 schematically shows the reachable set EM of flight paths for an aerial vehicle 1, for example according to FIG. 1, in a (flight) level x-z, which contains obstacles HI, in particular in an urban environment. The reachable set EM describes the set of deviations, limited by the extreme case, occurring from a commanded path KB of the aerial vehicle 1. This extreme case takes into consideration maximum-possible deviations, in particular due to wind (gusts), controller deviations, model quality, measurement inaccuracies, etc. The path planning takes into consideration the reachable set EM, as explained above in detail, and in this way ensures that no collision with obstacles HI takes place, even in an extreme case.

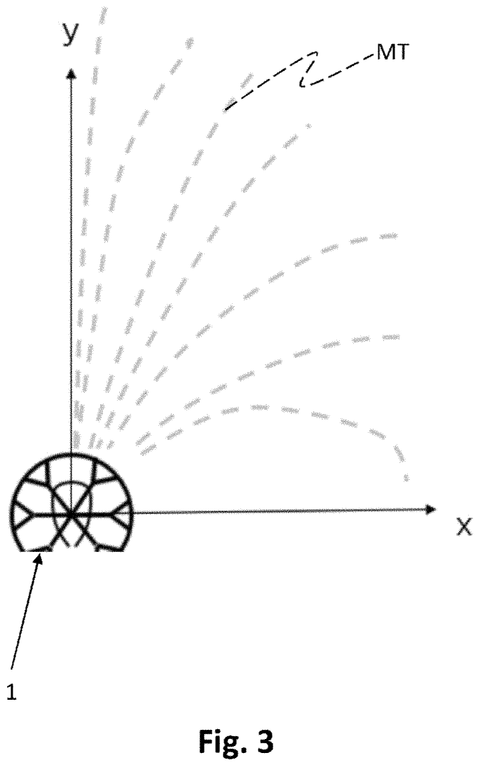

FIG. 3 schematically shows a content of the maneuver library, as explained in detail further above. For the aerial vehicle 1, so-called maneuver libraries are calculated. These consist of maneuvers that are completely precalculated and kept in the database, one arbitrary one of which or the corresponding trajectory in a level x-y selected by way of example is denoted in FIG. 3 by the reference sign MT. In the calculation of these maneuvers, the reachability set EM (cf. FIG. 2) is taken into consideration in each case, as described further above. Instead of a series of states, maneuvers are stored in the (maneuver) library as executable controllers. These controllers are optimized to the extent that the set of states that can be reached by the execution of a controller with the assumption of a limited disturbing effect or the possible deviation from the target state becomes minimal. The information concerning this reachable set is ascribed to the maneuver/controller as an attribute. The maneuver library comprises a discrete representation of the flight envelope while taking into consideration various performance states of the aerial vehicle (for example nominal state, failure scenarios, environmental conditions) and is optimized in terms of memory by using symmetries and superposition.

FIG. 4 shows a graphical representation of a mission planning for an aerial vehicle with nominal starting and target sites NP with an associated nominal trajectory NT, which connects the mentioned starting and target sites NP. Also shown are emergency or contingency trajectories CT to alternate landing sites AP, only some of which contingency trajectories CT are denoted in FIG. 4. A number of parameterized holding patterns WS with transition points (“x”) on the landing trajectories can likewise be seen. Such landing trajectories may likewise be of a nominal nature here. The aim is that parameterized sections lead back to trajectories that lead to a landing site. This may be both the nominal trajectory and an emergency trajectory. Furthermore, potential transition paths TP and a two-dimensionally defined transition interval TI are represented by way of example in the left half of the image. The transition paths TP make possible a transition between various contingency trajectories CT. Such transitions are also possible within the transition interval TI (flexibly, after calculation by the real-time control unit, cf. FIGS. 1 and 7).

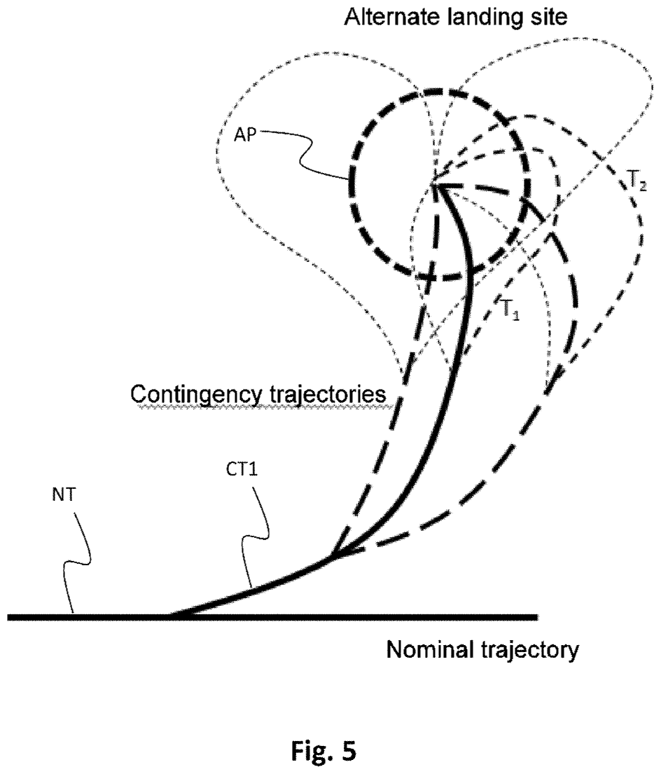

In FIG. 5, nested contingency trajectories, for example T₁, T₂, are shown in a tree structure, with a first contingency trajectory CT1, which branches off from the nominal trajectory NT, having further contingency trajectories of the first order (T₁) or higher-order (T₂) in turn branching off from it. The nominal trajectory NT, cf. FIG. 4, is represented at the bottom as a straight line.

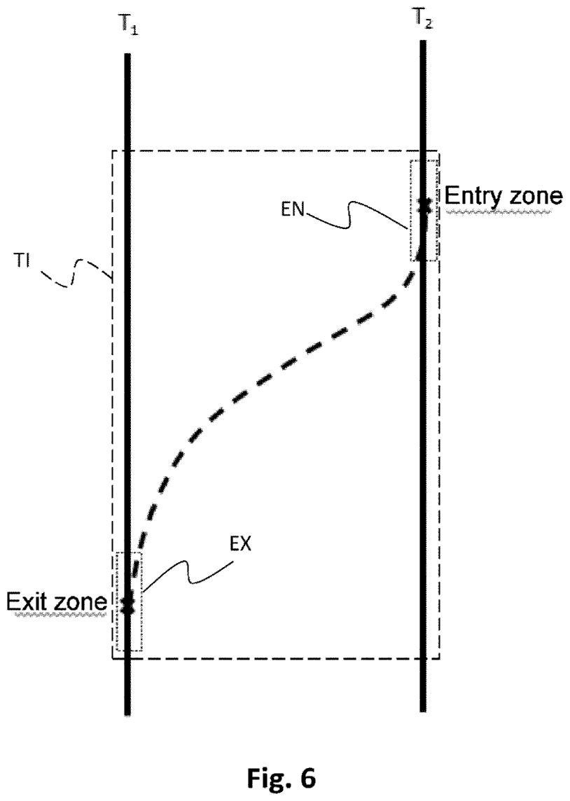

In FIG. 6 it is shown how an (online) transition, calculated in real time, between two precalculated trajectories T₁ and T₂ (cf. for example FIG. 4 or 5) can take place. The transition starts in a so-called predefined exit zone EX on the trajectory T₁ and runs to a so-called entry zone EN on the trajectory T₂. It is algorithmically ensured by the real-time control unit (cf. FIGS. 1 and 7) that the transition runs within the specified intervals (TI, cf. FIG. 4). This scenario is not restricted to specific types of trajectories T₁, T₂ (cf. also FIG. 5).

FIG. 7 shows a block diagram of the described path planning method with hardware allocation. The degree of detail and extent of the preplanning is in this case variable, as already explained in detail above.

The aerial vehicle 1 according to the right part of FIG. 7 comprises in addition to the already mentioned system monitor 2a, which interacts with the sensors and further information sources (denoted together by reference sign 4; cf. FIG. 1) for determining a state of the aerial vehicle 1 and its environment, the already mentioned real-time control unit 2b with a path-tracking controller 2c. Reference sign 2d denotes the actual flight control system, which acts on the drive units of the aerial vehicle 1 (cf. FIG. 1), in order to influence the aerial vehicle in its movement. Reference sign 2e shows the already repeatedly mentioned database, in which the (precalculated) trajectories and maneuvers are stored. Reference sign 2f represents the maneuver library with performance guarantee and map and meta data. The maneuver library 2f and the database 2e may be stored in a common memory unit. Furthermore, FIG. 7 also shows an (emergency) decision module 2g in operative connection with the system monitor 2a and also a transition module 2h comprising a transition planning algorithm (transition planner) 2h′ and a transition controller 2h″ in operative connection at least with the maneuver library 2f.

The left part of FIG. 7 shows a preplanning unit 6, which is preferably installed or executed on a ground-based user PC. The result of the preplanning is stored in the database 2e, preferably before a flight of the aerial vehicle 1. The preplanning unit 6 comprises the actual preplanning algorithm 6a, which receives as input data mission data 6b, aerial vehicle parameters 6c and map/meta data 6d. The preplanning algorithm 6a comprises modules for nominal planning 6e (nominal trajectory/trajectories), contingency planning 6f (emergency trajectories) and planning of the transition intervals 6g, from the interaction of which in the sequence shown the entire mission preplanning 6h is obtained and is preferably buffer-stored in a buffer memory at reference sign 6i.

In the use of the configuration according to FIG. 7, the following sequence is obtained: after preplanning has taken place (on the ground), an inquiry takes place at reference sign S1 as to whether or not the mission preplanning 6h is being released. It is preferably provided that a so-called U-Space operator or air traffic control center evaluates and releases the mission planning If it does, the preplanning is transferred to the aerial vehicle 1 and is stored in the database 2e. If not, the procedure returns to 6e (nominal planning).

The planning data in the database 2e are then used by the aerial vehicle 1 or the real-time control unit 2b during the flight. They are for example available to the path-tracking controller 2c and/or the decision module 2g, the latter also receiving event data (“events”) from the system monitor 2a. “Events” stands here for events in the context of event-based automatic machines. An event may therefore be: “EPU xyz failed” or “rescue helicopter from the left”, etc.

The output of the decision module 2g is a trajectory for the aerial vehicle 1, which is preferably selected situation-dependently from pre-planned trajectories and segments according to the criteria described in detail above. This trajectory is checked at S2 by the real-time control unit 2b for whether (on the basis of the event data) a so-called online transition is required, i.e. a change, determined in real time, to another (emergency) trajectory and/or flight level. If not, the path-tracking controller 2c takes over the further control of the aerial vehicle 1 along the (original) trajectory (see the corresponding operative connection with the flight control system 2d for the transmission of suitable control commands SK). If it is, the transition planner 2h′ of the transition module 2h becomes active, determines a change in trajectory (transition) on the basis of the precalculated maneuver etc. in the maneuver library 2f and provides a correspondingly changed control of the aerial vehicle 1 by way of the transition controller 2h″ of the transition module 2h (see the corresponding operative connection with the flight control system 2d for the transmission of suitable control commands SK). Feedback in the form of a verification (at S3) as to whether the transition was successful takes place by way of the system monitor 2a. Discrete changes of the flight altitude can be implemented as and when required alone on the basis of a controller and without the need for a preceding planning algorithm. This takes place alone by the transition controller 2h″ of the transition module 2h.

1. A method for controlling an aerial vehicle (1) of a specific type, the method comprising:
a) before a flight, calculating and storing a finite number of nominal trajectories (NT) for the aerial vehicle (1) and a finite number of emergency trajectories (CT) arranged around the nominal trajectories (NT) in a database (2e) available on board the aerial vehicle (1);
b) before the flight, pre-planning and storing a finite number of type-specific admissible flying maneuvers of the aerial vehicle (1) in the database as a maneuver library (2f);
c) before the flight, defining and storing a number of discrete flight levels with different flight altitudes are defined and stored in the database (2e);
d) during the flight, accessing the database (2e) within a real-time algorithm (2b) by a computer-aided transition planning algorithm (2h′), in order, depending on a state of the aerial vehicle (1) recorded by sensors (4), to change between the nominal trajectories (NT) and the emergency trajectories (CT) and also between the defined flight levels by using the pre-planned flying maneuvers and to correspondingly activate at least one of a path-tracking controller (2c) or a flight control system (2d) of the aerial vehicle (1).

2. The method as claimed in claim 1, wherein the emergency trajectories (CT) are arranged in at least one of a tree structure or at regular intervals.

3. The method as claimed in claim 2, wherein the path planning in step a) takes place by quasi-random algorithms for path planning, which process is repeated up to a desired degree of branching on the emergency trajectories (CT) generated in a previous step, so as to produce a tree-like flight path structure.

4. The method as claimed in claim 1, wherein the transition planning algorithm (2h′) has a restricted time horizon.

5. The method as claimed in claim 1, wherein steps a) to c) are performed on a ground-based computer and a result is subsequently transferred to the aerial vehicle (1) and is stored on board the aerial vehicle in the database (2e); or steps a) to c) are performed on an on-board computer of the aerial vehicle (1) and the result is stored on board the aerial vehicle (1) in the database (2e).

6. The method as claimed in claim 1, wherein, before the flight, entry and exit intervals (TI, EN, EX) are defined for each said trajectory and a change between the trajectories and the flight levels is only admissible within the entry and exit intervals (TI, EN, EX).

7. The method as claimed in claim 1, further comprising, in step d), determining by interaction of an emergency module (2g) and the transition planning algorithm (2h′) based on aerial-vehicle-specific parameters and environment variables whether a transition is required, and if so to which of the at least one of the trajectory or the flight level.

8. The method as claimed in claim 1, wherein, in step d), horizontal transitions between different ones of the trajectories are carried out completely decoupled from vertical transitions between different ones of the flight levels.

9. The method as claimed in claim 1, wherein, in step a), both a combination of individual trajectories and closed sets of reachable trajectories are calculated, said reachable trajectories are obtained from the pre-planned trajectories and transition intervals (TI) between the pre-planned trajectories.

10. The method as claimed in claim 1, wherein reachability sets (EM) are determined based on at least one of the following:
i) disturbing effects during nominal operation including at least one of maximum wind and gust strength;
ii) known flight performance parameters including at least one dynamics and kinematics of the aerial vehicle (1); or
iii) model quality provided as a deviation between a physical model of the aerial vehicle (1), used as a basis at least for step a), and an observed or measured flying behavior.

11. The method as claimed in claim 10, wherein the reachability sets (EM) are used for the pre-planning of the flying maneuvers in step b).

12. The method as claimed in claim 1, further comprising providing at least one of landing site information, hazard potentials, or airspace structures in an expanded 3D map of a flying area, said map serving as a basis for the trajectory planning in step a).

13. The method as claimed in claim 1, further comprising, in step d), carrying out a time-incremental real-time planning of the actual flight path along one of the nominal trajectories (NT) and within the set of all of the emergency trajectories (CT) on board the aerial vehicle (1), including:
i) updating a system state of the aerial vehicle (1);
ii) derived from the updating of the system state, updating the trajectory and flight level to be flown;
iii) updating a selected path from the previous time increment while taking into consideration an evaluation function and, if needed, a transition to a new path, using a model-based planning method with a restricted time horizon.

14. The method as claimed in claim 1, wherein the maneuver library (2f) comprises a discrete representation of a flight envelope of the aerial vehicle (1) taking into consideration various performance states of the aerial vehicle (1), such as a nominal state, failure scenarios or environmental conditions, and is stored in an optimized manner in a memory using symmetries and superposition.

15. The method as claimed in claim 1, wherein additionally parameterized trajectory segments are defined and stored in the database (2e), the trajectory segments being flight paths or partial flight paths that are locally performable, do not entail any change of a selected one of the trajectories but return to this trajectory once they have ended.

16. The method as claimed in claim 1, wherein each said trajectory is characterized based on properties stored in the database (2e), and the transition planning algorithm (2h′) makes decisions in step d) concerning the trajectory selection based on said properties.

17. The method as claimed in claim 1, wherein a change of the at least one of the flight level or trajectory takes place at a nearest branching point of a tree structure in which the emergency trajectories (CT) are arranged or by the transition planning algorithm (2h′) in a nearest one of an entry or an exit interval entry (TI, EN, EX) defined pre-flight for each said trajectory if no transition along the tree structure is possible.

18. The method as claimed in claim 1, wherein, as a mission increasingly progresses, the trajectories that cannot be reached any longer are removed and the set of trajectories taken into consideration is reduced to a set of the trajectories that are still reachable in a current flying state of the aerial vehicle (1).

19. A computer-aided system for controlling an aerial vehicle (1) of a specific type by the method according to claim 1, wherein the aerial vehicle is a multirotor VTOL aerial vehicle with electrically driven rotors (3b), with at least one computer, which is configured as at least one of a ground-based computer unit or as an on-board computer of the aerial vehicle (1), the at least one computer being configured for:
A) performing a preplanning algorithm for carrying out method step a);
B) providing the database (2e);
C) performing the real-time algorithm (2b) which provides a decision module, an input of which is the state of the aerial vehicle (1) according to method step d) and an output of which is one of the trajectories that corresponds best to the current state of the aerial vehicle (1) from the finite number of nominal trajectories (NT) and the emergency trajectories (CT) in accordance with an evaluation metric; and
D) performing the transition planning algorithm (2h′) according to method step d).

20. The system as claimed in claim 19, wherein the preplanning algorithm (6a) has: inputs for map data (6d) provided as popular map formats and for starting and target coordinates and outputs for geo-referenced, parameterized or non-parameterized trajectories with exit and entry intervals (EX, EN), and parameterized trajectory segments for changes of at least one of flight level or holding patterns, which are at least one of transferrable to the database (2e) or storable in the database (2e).

21. The system as claimed in claim 19, wherein the transition planning algorithm (2h′) has: inputs for a state vector consisting of a state estimation of the aerial vehicle (1) for exit and entry intervals (EX, EN) from the database (2e), for starting and target states from the database (2e), for the maneuver library (2f), for a target trajectory and target flight level and for a maneuver prioritization from the database (2e), and an output for a path vector (p, \dot{p}, \ddot{p}, [symbol] , ψ, \dot{ψ}, \ddot{ψ}) for outputting to a position controller of the aerial vehicle (1) with a position specification p and temporal derivatives thereof, and a yaw angle Ψ and temporal derivatives thereof.

22. The system as claimed in claim 21, wherein the inputs for the state vector consisting of the state estimation of the aerial vehicle (1) are in the form of a sensor data fusion of different sensors (4).

23. The system as claimed in claim 19, wherein the real-time algorithm (2b) is configured to select at each time increment between a finite number of discrete ones of the trajectories that respectively corresponds to the nominal trajectory (NT), one of the emergency trajectories (CT), or a trajectory segment to be performed temporarily.

24. The system as claimed in claim 20, wherein the transition planning algorithm (2h′) is configured for instigating a change between the trajectories that are not replicated in a tree structure in which the emergency trajectories (CT) are arranged within the exit and entry intervals (EX, EN).

25. An aerial vehicle (1) comprising the system according to claim 19.

26. A method for controlling an aerial vehicle (1) of a specific type, the method comprising:
before a flight, calculating and storing a finite number of nominal trajectories (NT) for the aerial vehicle (1) and a finite number of emergency trajectories (CT) arranged around the nominal trajectories (NT) in a database (2e) available on board the aerial vehicle (1);
before the flight, pre-planning and storing a finite number of type-specific admissible flying maneuvers of the aerial vehicle (1) in the database as a maneuver library (2f);
during the flight, accessing the database (2e) within a real-time algorithm (2b) by a computer-aided transition planning algorithm (2h′), in order, depending on a state of the aerial vehicle (1) recorded by sensors (4), to change between the nominal trajectories (NT) and the emergency trajectories (CT) and to correspondingly activate at least one of a path-tracking controller (2c) or a flight control system (2d) of the aerial vehicle (1).
